(19) United States
(12) Patent Application Publication
(10) Pub. No.: US 2026/0225164 A1
(43) Pub. Date: Aug. 6, 2026

(54) PRECISION GUIDE FOR A BOWLING BALL DRILL BIT

(71) Applicant: Christopher Hook, Eastvale, CA (US)

(72) Inventor: Christopher Hook, Eastvale, CA (US)

(21) Appl. No.: 19/046,533

(22) Filed: Feb. 6, 2025

(51) Int. Cl. B23B 41/02; B23B 47/26; B23B 47/28; B23B 49/02; B23B 51/00; B23B 51/04

(52) U.S. Cl. CPC B23B 41/02; B23B 47/26; B23B 47/282; B23B 49/02; B23B 51/0004; B23B 51/0461

(57) ABSTRACT

A precision guide for a drill bit used in bowling ball manufacturing is disclosed, including a shaft including a first end and a second end, the first end being insertable into a drill chuck and the second end constructed to releasably attach to a plurality of drill bits each constructed having a specified dimension. The plurality of drill bits include a convex surface formed to match a surface of a bowling ball to enable the cutting of at least one finger insert, and at least one thumb slug.

### TECHNICAL FIELD

The embodiments generally relate to tools utilized during the production of bowling balls, and more specifically to a precision guide used when manufacturing blowing ball finger inserts, and thumb slugs.

### BACKGROUND

Bowling balls are hard spherical balls used to knock down bowling pins in the sport of bowling. It is common for bowling balls to include holes for two fingers and a thumb which aid the player in holding the ball prior to and while delivering the bowling ball down the lane. The drilling layout of the bowling ball refers to how and wherein each hole is drilled in relation to the ball's locator pin and mass bias. Holes are drilled for a conventional grip, a fingertip grip, or a number of other grips used by players. Finger inserts and thumb slugs are custom-fit tubes inserted into the drilled holes which can be used to improve grip and enhance the torque delivered when delivering the bowling ball.

It is imperative that the bowling ball receives finger and thumb holes drilled at precise positioned on the surface of the ball. Traditional methods have relied on visual approximation and hand-drawn guidelines. More accurate means of drilling the holes may be implemented to increase the players consistency and comfort while bowling.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments disclosed herein relate to a precision guide for a drill bit used in bowling ball manufacturing. The precision guide and drill bit include a shaft including a first end and a second end, the first end being insertable into a drill chuck and the second end constructed to releasably attach to a plurality of drill bits each constructed having a specified dimension. The plurality of drill bits include a convex surface formed to match a surface of a bowling ball to enable the cutting of at least one finger insert, and at least one thumb slug.

In some aspects, each of the plurality of drill bits includes a bezel.

In some aspects, the bezel corresponds to a dimension of the drill bit.

In some aspects, the bezel is utilized to align a template with the circumference of the bezel.

In some aspects, the precision guide includes a bowling ball mounting mechanism to secure the bowling ball under a drill.

In some aspects, the bowling ball mounting mechanism includes an adjustable retainer to retain the bowling ball in a fixed position under the drill.

In some aspects, the adjustable retainer includes an adjustment mechanism to enable the adjustment of the position of the bowling ball to enable a user to align the template to the bezel.

In some aspects, the plurality of drill bits are provided as a set, the set including a plurality of circumferences to enable the selection of a suitable drill bit.

In some aspects, the plurality of circumferences include a first set dimensioned to manufacture the at least one finger insert, and a second set dimensioned to manufacture the at least one thumb slug.

These and other objects, features, and advantages of the present invention will become more readily apparent from the attached drawings and the detailed description of the preferred embodiments, which follow.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of the precision guide for a bowling ball drill bit being used to cut the finger inserts and thumb slug of a bowling ball, according to some embodiments;

FIG. 2 illustrates a perspective view of the drill bit for the precision cutting of a bowling ball finger inserts and thumb slug, according to some embodiments;

FIG. 3 illustrates a top plan view of the shaft and a plurality of drill bits which can be releasably connected to the shaft; and

FIG. 4 illustrates a perspective view of the blowing ball mount having a bowling ball placed on the mount, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a precision guide for a bowling ball drill bit used when drilling the finger and thumb holes wherein the finger inserts, and thumb guide are positioned. In particular, the embodiments include a drill press used to connect to the drill bit. The drill bit includes a shaft which is insertable into the drill chuck and an interchangeable bit. Each bit corresponds to a size of a hole needed to be drilled into the bowling ball to form the holes where the finger inserts, and thumb slug are inserted.

During use, the shaft is connected, via threading or similar means of connection, to the selected drill bit. The drill bit is selected based of the size of the hole needed for holes of the bowling ball which are used to receive the finger inserts and thumb slugs. Once the drill bit is connected, the shaft is then connected to the drill chuck of the drill press. The bowling ball is then adjusted to align a template illustrating where the holes are to be cut with the drill bit. The user may lower the drill bit to contact or nearly contact the surface of the bowling ball to ensure proper positioning. The bowling ball is then locked in place with a mounting mechanism which retains the bowling ball in a fixed position throughout the drilling process. The mounting mechanism may then be loosened to allow the user to move the bowling ball to adjust the drill bit over the next hole to be drilled. If the user determines a new drill bit should be attached, the previous drill bit is disengaged from the shaft, and the new selected drill bit is attached to the shaft. This process is repeated for each hole that is drilled in the bowling ball.

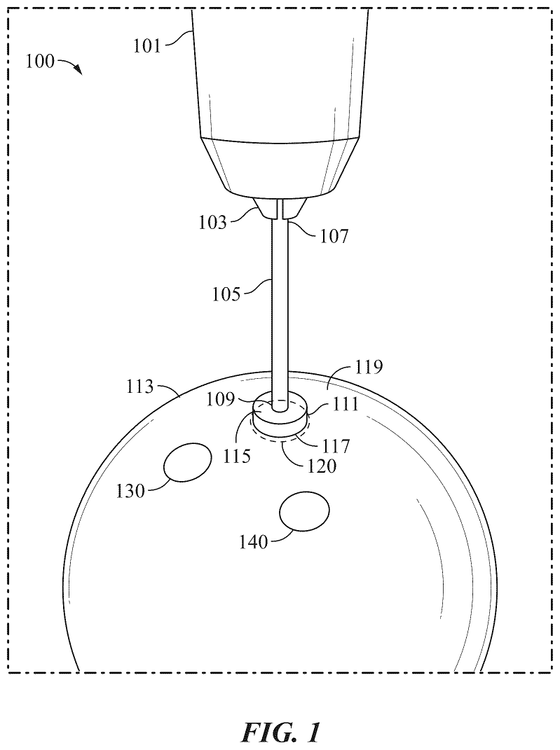

FIG. 1 illustrates the precision guide for a bowling ball drill bit being used to cut the finger inserts and thumb slug of a bowling ball. The bowling ball is in a position such that the drill bit is able to cut the finger guide hole 120. The system 100 includes a drill press 101 having a drill chuck 103 capable of connecting to a shaft 105. The shaft 105 includes a first end 107 and a second end 109. The first end 107 is insertable into the drill chuck 103 and the second end 109 is threadingly connected to one of a plurality of drill bits 111 to enable each drill bit 111 to releasably attach the shaft 105. In such, the user may select a suitable drill bit 111 which has a specified dimension (i.e., a labeled circumference, diameter, or other measurement) which is sufficient for drilling a hole in the bowling ball 113. The shaft 105 connects to a top surface 115 of the drill bit 111 having a threaded hole while the bottom surface 117 of the drill bit 111 is convex which is complimentary to the exterior surface 119 of the bowling ball 113.

In some embodiments, the exterior surface 119 of the bowling ball 113 may include a template which aids the user in aligning the drill bit 111 with the each finger hole 120,130 and the thumb hole 140 such that they may receive finger inserts (inserted into each finger hole 120,130) and thumb guide/slug (inserted into the thumb hole 140).

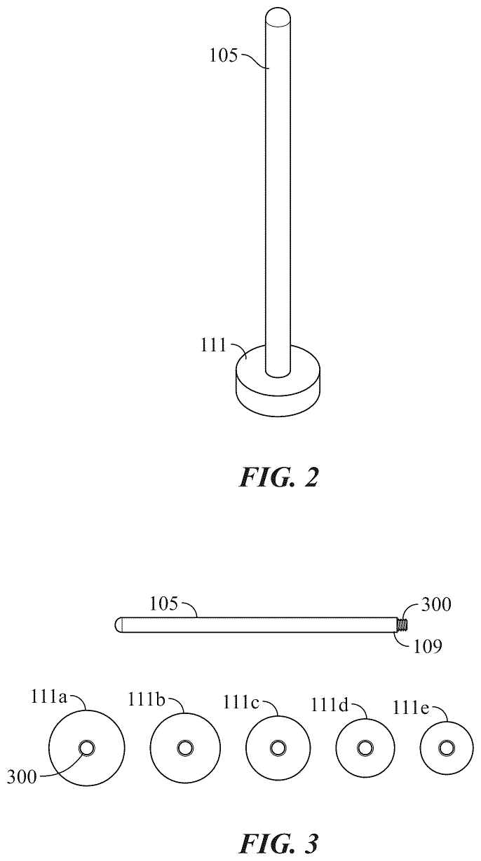

FIG. 2 illustrates the drill bit for the precision cutting of a bowling ball finger inserts and thumb slug which includes the shaft 105 and the drill bit 111. FIG. 3 illustrates the shaft 105 and a plurality of drill bits 111a-111e which can be releasably connected to the shaft 105 via threading 300 positioned on the second end 109 thereof. The threading 300 may be threadingly connected to the threaded opening 301 (illustrated on drill bit 111a, while it is to be understood that each drill bit includes the same threading). This allows the user selectively to connect and disconnect each drill bit as needed depending on the size of the hole to be drilled on the bowling ball.

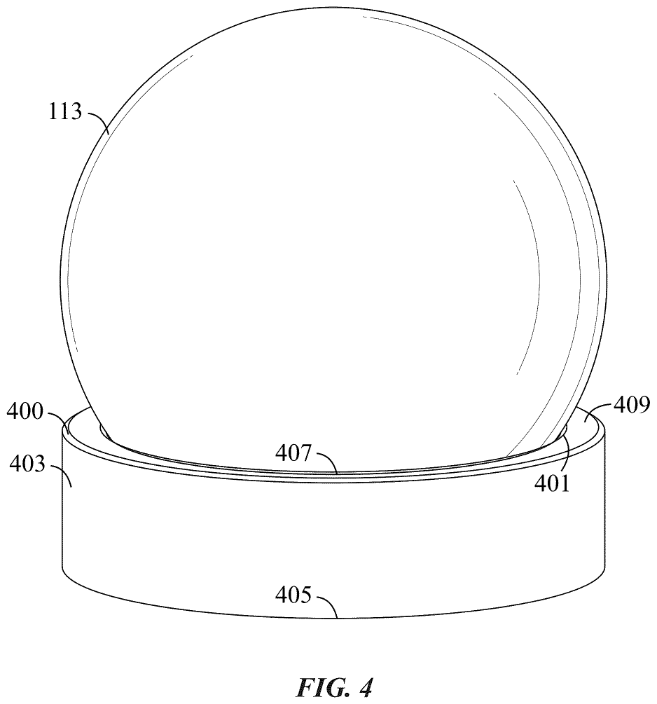

FIG. 4 illustrates the bowling ball mount 400 bowling ball mount to adjustably retain a bowling ball 113 in a suitable position under a drill and drill chuck (see FIG. 1 for depiction of the drill, drill chuck and drill bit connected to the shaft). The bowling ball mount 400 includes a receiver 401 which is dimensioned to partially receive the bowling ball 113 and retain the bowling ball in position. The receiver 113 has a concave shape within the sidewall of 403 to enable the bowling ball 113 to be rolled into position during the drilling process. In such, the bowling ball mount 400 remains in a fixed position while the bowling ball 113 is rolled into a suitable position to align the hole with the drill bit. During use, the flat bottom surface 405 of the bowling ball mount 400 is placed on a stable work surface and the bowling ball 113 is positioned in the receiver 401 located at the top 407 of the bowling ball mount 400. The receiver 401 defines the central portion of the top 407 of the bowling ball mount, wherein an edge 409 extends upwards on the bowling ball 113 to retain it within the receiver 401.

Since many modifications, variations, and changes in detail can be made to the described preferred embodiments of the invention, it is intended that all matters in the foregoing description and shown in the accompanying drawings be interpreted as illustrative and not in a limiting sense. Thus, the scope of the invention should be determined by the appended claims and their legal equivalents.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A precision guide for a drill bit used in bowling ball manufacturing, comprising:
a shaft including a first end and a second end, the first end being insertable into a drill chuck and the second end constructed to releasably attach to a plurality of drill bits each constructed having a specified dimension,
wherein the plurality of drill bits including a convex surface formed to match a surface of a bowling ball to enable cutting of at least one of the following: at least one finger insert, and at least one thumb slug.

2. The precision guide of claim 1, wherein each of the plurality of drill bits includes a bezel.

3. The precision guide of claim 2, wherein the bezel corresponds to a dimension of the drill bit.

4. The precision guide of claim 3, wherein the bezel is utilized to align a template with a circumference of the bezel.

5. The precision guide of claim 1, further comprising a bowling ball mounting mechanism to position the bowling ball under a drill.

6. The precision guide of claim 5, wherein the bowling ball mounting mechanism includes an adjustable retainer to retain the bowling ball in a fixed position under the drill.

7. The precision guide of claim 6, wherein the adjustable retainer includes an adjustment mechanism to enable adjustment of a position of the bowling ball to enable a user to align the template to the bezel.

8. The precision guide of claim 1, wherein the plurality of drill bits are provided as a set, the set including a plurality of circumferences to enable the selection of a suitable drill bit.

9. The precision guide of claim 8, wherein the plurality of circumferences include a first set dimensioned to manufacture the at least one finger insert and a second set dimensioned to manufacture the at least one thumb slug.

10. A system for the precision drilling of a bowling ball, the system comprising:
a shaft including a first end and a second end, the first end being insertable into a drill chuck and the second end constructed to releasably attach to a plurality of drill bits each constructed having a specified dimension corresponding to the at least one finger insert and the at least one thumb slug; and
a bowling ball mount to adjustably retain a bowling ball in a suitable position under a drill, the drill connected to the drill chuck,
wherein the plurality of drill bits including a convex surface formed to match a surface of a bowling ball to enable cutting of at least one of the following: at least one finger insert, and at least one thumb slug.

11. The precision guide system of claim 10, wherein each of the plurality of drill bits includes a bezel.

12. The precision guide system of claim 11, wherein the bezel corresponds to a dimension of the plurality of drill bits.

13. The precision guide system of claim 2, wherein the bezel is utilized to align a template with a circumference of the bezel.

14. The precision guide system of claim 13, further comprising a bowling ball mounting mechanism to position the bowling ball under a drill.

15. The precision guide system of claim 14, wherein an adjustment mechanism enables the adjustment of a position of the bowling ball to enable a user to align the template to the bezel.

16. The precision guide system of claim 15, wherein the plurality of drill bits are provided as a set, the set including a plurality of circumferences to enable the selection of a suitable drill bit.

17. The precision guide system of claim 16, wherein the plurality of circumferences include a first set dimensioned to manufacture the at least one finger insert and a second set dimensioned to manufacture the at least one thumb slug.
